(19) United States
(12) Patent Application Publication
(10) Pub. No.: US 2007/0268794 A1
(43) Pub. Date: Nov. 22, 2007

(54) Beam splitter configuration

(75) Inventor: Wieland Hill, Dortmund (DE)

Correspondence Address: LERNER GREENBERG STEMER LLP, P O BOX 2480, HOLLYWOOD, FL, 33022-2480, US

(73) Assignee: Hentze-Lissotschenko Patentverwaltungs GmbH & Co. KG

(21) Appl. No.: 11/825,197

(22) Filed: Jul. 5, 2007

Related U.S. Application Data
(63) Continuation of application No. PCT/EP05/00020, filed on Jan. 4, 2005.

(51) Int. Cl. G11B 7/00

(52) U.S. Cl. 369/44.23

(57) ABSTRACT

A beam splitter configuration includes at least one beam splitting system for splitting a light beam into a number of partial beams. The beam splitting system includes at least one first and at least one second optical array disposed at a distance from one another and having a number of optically functional elements. An integral multiple of the optically functional elements of the first optical array is assigned to each optically functional element of the second optical array.

### CROSS-REFERENCE TO RELATED APPLICATION

This is a continuing application, under 35 U.S.C. § 120, of copending International Application No. PCT/EP2005/000020, filed Jan. 4, 2005, which designated the United States; the prior application is herewith incorporated by reference in its entirety.

### BACKGROUND OF THE INVENTION

1. Field of the Invention

The present invention relates to a beam splitter configuration including at least one beam splitter system for decomposing a light beam into a plurality of component beams.

Beam splitter configurations of the type mentioned at the outset are already known from the prior art in various embodiments. For example, a light beam can be decomposed into two component beams with the aid of a partially reflecting mirror that can be used as a beam splitter system. A correspondingly large number of partially reflecting mirrors are required as the beam splitter system in order to be able to generate a large number of component beams. Very high-quality and precise reflective coatings are required in order to be able to split the radiant power as exactly as possible into the individual component beams. Likewise known from the prior art are beam splitter configurations that operate with polarization optics or with mirrors introduced partially into the beam path. Such beam splitter configurations likewise require very many individual components for generating a large number of component beams.

Important technical applications such as, for example, the simultaneous laser drilling of workpieces or the measurement of sample arrays with the aid of laser beams, require the splitting of a primary laser beam into a multiplicity of component beams. The above-described beam splitter system can only implement such an operation with a very high outlay.

So-called diffractive beam splitter systems have been developed in order to be able to generate very many component beams with relatively few individual optical components. An example of those diffractive beam splitter systems is shown in the journal “Laser Focus World” (December 2003, pages 73 to 75). Those components, which are complicated to construct and manufacture, can decompose a light beam very uniformly and precisely into a multiplicity of component beams. A disadvantage of the diffractive beam splitter system known from the prior art resides, inter alia, in that their efficiency is only of an order of magnitude of approximately 80%, since substantial fractions of the light primarily irradiated is lost through scattering and diffraction into higher orders. The comparatively sharp structures of the diffractive beam splitter system can reduce the durability and service life, particularly in the case of relatively high light intensities.

The present invention starts from that point.

### SUMMARY OF THE INVENTION

It is accordingly an object of the invention to provide a beam splitter configuration, which overcomes the hereinafore-mentioned disadvantages of the heretofore-known devices of this general type, which can be manufactured simply and therefore cost effectively and which enables a relatively uniform splitting of light or other electromagnetic radiation into a plurality of component beams in conjunction with low losses.

With the foregoing and other objects in view there is provided, in accordance with the invention, a beam splitter configuration, comprising at least one beam splitter system for decomposing a light beam into a plurality of component beams. The beam splitter system includes at least one first and at least one second optical array being spaced apart from one another and having a plurality of optically functional elements. An integral multiple of the optically functional elements of the first optical array are assigned to each respective optically functional element of the second optical array.

Consequently, a light beam striking the beam splitter configuration is decomposed into a plurality of individual component beams. The number of the generated component beams is a function, inter alia, of the number of the optically functional elements of the first optical array, which are respectively assigned to an optically functional element of the second optical array. In order to be able to meet this assignment condition, the diameters of the optically functional elements of the first optical array can be smaller than the diameters of the optically functional elements of the second optical array. It is also possible to meet the assignment condition in another way, for example through the use of a particular shaping of the optically functional elements of the optical arrays.

In accordance with another feature of the invention, the optically functional elements of the optical arrays are lens elements. Optical arrays with lens elements can be manufactured with high precision in a way that is relatively simple and therefore cost effective. In this embodiment, a light beam striking the beam splitter configuration can be decomposed with the aid of the lens elements of the first optical array into a plurality of component beams that are imaged in a focal plane of the lens elements of the first optical array. The second optical array, which likewise has lens elements, is then used as Fourier optics. There is then generated in the far field of each individual lens element of the second optical array an angular distribution of the light intensity that corresponds to the intensity distribution in the focal plane of this corresponding lens element upstream of the second optical array.

In accordance with a further feature of the invention, the optical arrays are disposed in such a way that the lens elements of the second optical array and the lens elements, assigned to them, of the first optical array, have common focal planes. Component beams with low divergence and different propagation angles in the far field of the second optical array can be generated in this way.

In accordance with an added feature of the invention, at least a portion of the lens elements preferably has a convex construction. In this case, the splitting of a light beam, incident on the beam splitter configuration, into a plurality of component beams, can be performed at least partially in the real domain.

In accordance with an additional feature of the invention, at least a portion of the lens elements can have a concave construction. It is then possible for a light beam falling onto the beam splitter configuration to be split into a plurality of component beams at least partially in the virtual domain.

In accordance with yet another preferred feature of the invention, the lens elements of at least one of the optical arrays can be spherical lens elements.

In accordance with yet a further feature of the invention, the lens elements of at least one of the optical arrays are cylindrical lens elements.

It is possible in principle to use lens elements with any other desired lens shapes in the optical arrays. However, it is generally optical arrays which take up as much area as possible that are particularly advantageous for achieving as high an efficiency of the beam splitter configuration as possible. Rectangular or else hexagonal lens elements, in particular, can be used to this end.

In accordance with yet an added feature of the invention, at least one of the optical arrays has first and second cylindrical lens elements on opposite sides. The cylinder axes of the first cylindrical lens elements on a rear side of the at least one of the optical arrays are respectively oriented parallel to one another and perpendicular to the cylinder axes of the second cylindrical lens elements on a front side of the at least one of the optical arrays. Such cylindrical lens arrays having cylindrical lens elements which have cylinder axes oriented perpendicular to one another on opposite sides are suitable, in particular, for decomposing a light beam striking the beam splitter configuration into a two-dimensional configuration of component beams.

In accordance with yet an additional feature of the invention, the beam splitter configuration has at least one lens system that is disposed in the beam path of the beam splitter configuration downstream of the second optical array and is suitable for focusing the component beams onto a focal plane. The lens system carries out a second Fourier transformation of the component beams that traverse the lens system. The effect of the now twofold Fourier transformation through the use of the second optical array and of the lens system is that the component beams are imaged into a focal plane downstream of the lens system. By way of example, a point pattern can be generated in this way in the focal plane of the lens system.

In accordance with again another feature of the invention, the lens system can preferably have a spherical construction.

In accordance with a concomitant feature of the invention, in a variant of the beam splitter configuration, the optically functional elements of at least one of the optical arrays can be mirrors. Mirror arrays deliver comparable results and are particularly advantageous whenever the electromagnetic radiation striking the beam splitter configuration is attenuated upon transmission through lens elements, or is not sufficiently refracted.

Other features which are considered as characteristic for the invention are set forth in the appended claims.

Although the invention is illustrated and described herein as embodied in a beam splitter configuration, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, side-elevational view of a beam splitter configuration in accordance with a first embodiment of the present invention;

FIG. 2 is a fragmentary, plan view of the beam splitter configuration in accordance with FIG. 1;

FIG. 3A is a simplified illustration of a first and a second optical array of the beam splitter configuration in accordance with FIG. 1 and FIG. 2, as well as a point pattern generated with the beam splitter configuration;

FIG. 3B is a simplified illustration of a first alternative variant of the optical arrays of the beam splitter configuration, and the generated point pattern;

FIG. 3C is a simplified illustration of a second alternative variant of the optical arrays of the beam splitter configuration, as well as the generated point pattern; and

FIG. 4 is an enlarged, fragmentary, side-elevational view of a beam splitter configuration in accordance with a second embodiment of the present invention.

### DETAILED DESCRIPTION OF THE INVENTION

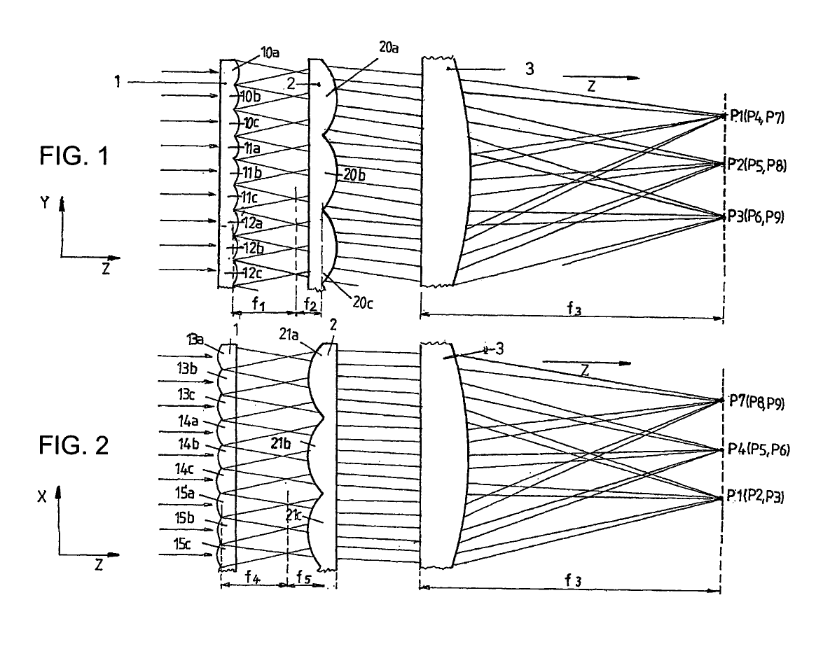

Referring now to the figures of the drawings in detail and first, particularly, to FIGS. 1 and 2 thereof, there are seen two views of a beam splitter configuration in accordance with a first embodiment of the present invention. In this case, FIG. 1 shows a diagrammatic side view, and FIG. 2 a plan view of the beam splitter configuration in accordance with FIG. 1. For the purpose of explanation, Cartesian coordinate systems are respectively depicted in FIG. 1 and FIG. 2.

The beam splitter configuration includes a first optical array 1 that has a plurality of convexly shaped first cylindrical lens elements 10a-12c (see FIG. 1) on its rear side, and a plurality of convexly shaped second cylindrical lens elements 13a-15c (see FIG. 2) on its front side. Alternatively, at least a portion of the first and second cylindrical lens elements 10a-12c, 13a-15c of the first optical array 1 can also have a concave construction. In this exemplary embodiment, the first and second cylindrical lens elements 10a-12c, 13a-15c have largely identical diameters and curvatures. It is to be seen that the cylinder axes of the first cylindrical lens elements 10a-12c on the rear side of the first optical array 1 respectively run substantially parallel to one another, and are substantially oriented perpendicular to the cylinder axes, likewise running substantially parallel to one another, of the second cylindrical lens elements 13a-15c on the front side of the first optical array 1. In principle, any desired shape and configuration of the lens elements in the first optical array 1 is possible. For example, instead of the cylindrical lens elements 10a-12c, 13a-15c, it is also possible to use spherical lens elements.

A second optical array 2 is disposed downstream of the first optical array 1 in the beam propagation direction (z-direction). This second optical array 2 likewise has on its rear side a plurality of convexly shaped first cylindrical lens elements 20a-20c having cylinder axes which run substantially parallel to one another. On its front side, the second optical array 2 has a plurality of convexly shaped second cylindrical lens elements 21a-21c having cylinder axes which are likewise oriented substantially parallel to one another and perpendicular to the cylinder axes of the first cylindrical lens elements 20a-20c. Alternatively, it is also possible for at least a portion of the cylindrical lens elements 20a-20c, 21a-21c of the second optical array 2 to have a concave construction. Alternatively, it is possible for differently shaped and differently disposed lens elements (for example spherical lens elements) to be used in the second optical array 2. It is to be seen that the diameters of the first and second cylindrical lens elements 20a-20c, 21a-21c of the second cylindrical lens array 2 are larger in this exemplary embodiment than the diameters of the first and second cylindrical lens elements 10a-12c, 13a-15c of the first optical array 1. The diameters of the comparatively small cylindrical lens elements 10a-12c, 13a-15c of the first optical array 1 can, for example, be of an order of magnitude of 0.1 to 1 mm.

It is clear from FIG. 1 that in each case one of the first cylindrical lens elements 20a-20c on the rear side of the second optical array 2 is assigned exactly three of the first cylindrical lens elements 10a-12c on the rear side of the first optical array 1. For example, the cylindrical lens element 20a of the second optical array 2 is assigned the cylindrical lens elements 10a, 10b, 10c of the first optical array 1. A corresponding statement holds for the cylindrical lens element 20b, which is assigned the cylindrical lens elements 11a, 11b, 11c of the first optical array 1, and for the cylindrical lens element 20c, which is assigned the cylindrical lens elements 12a, 12b, 12c of the first optical array 1.

It is clear from the plan view shown in FIG. 2, which is rotated by 90° with reference to FIG. 1, that in each case one of the second cylindrical lens elements 21a-21c on the front side of the second cylindrical lens array 2 is assigned exactly three of the second cylindrical lens elements 13a-15c on the front side of the first cylindrical lens array 1. Thus, the cylindrical lens element 21a of the second optical array 2 is assigned the cylindrical lens elements 13a, 13b, 13c of the first optical array 1. A corresponding statement holds for the cylindrical lens element 21b, which is assigned the cylindrical lens elements 14a, 14b, 14c of the first optical array 1, and for the cylindrical lens element 21c, which is assigned the cylindrical lens elements 15a, 15b, 15c of the first optical array 1.

Irrespective of the selected geometric shape and configuration of the lens elements, it is worthy of note that the ratio of the total number of the lens elements of the first optical array 1 to the total number of the lens elements of the second optical array 2 is an integer. The lens elements may also be referred to as optically functional elements.

In addition to the two optical arrays 1, 2, the beam splitter configuration has a lens system 3 that in this exemplary embodiment has a spherical construction and is disposed downstream of the second optical array 2 in the z-direction (beam propagation direction). It is understood that the lens system 3 can be one lens or a multiplicity of lenses.

A substantially parallel light beam striking the beam splitter configuration shown in FIG. 1 and FIG. 2 is firstly decomposed through the use of the first optical array 1 into a plurality of component beams. The splitting of the light beam into a plurality of component beams is performed in the real domain in the exemplary embodiment shown herein, since both the cylindrical lens elements 10a-12c, 13a-15c of the first optical array 1, and the cylindrical lens elements 20a-20c, 21a-21c of the second optical array 2 are respectively of convex construction. If, alternatively, the convex cylindrical lens elements 10a-12c, 13a-15c, 20a-20c, 21a-21c in the two optical arrays 1, 2 are replaced by concavely shaped cylindrical lens elements, the splitting of the incident light beam into a plurality of component beams is performed, in contrast, in the virtual domain.

Since the first cylindrical lens elements 10a-12c on the rear side of the first optical array 1 have substantially identical geometric (diameter and curvature) and optical properties, all of the first cylindrical lens elements 10a-12c, respectively have a common focal plane at a distance f1 downstream of the first optical array 1 (see FIG. 1). A corresponding statement holds for the second cylindrical lens elements 13a-15c on the front side of the first optical array 1 and their common focal plane at a distance f4 downstream of the first optical array 1 (see FIG. 2). The first and second cylindrical lens elements 20a-20c, 21a-21c of the second optical array 2 also respectively have common focal planes upstream of the second optical array 2. The common focal plane of the first cylindrical lens elements 20a-20c of the second optical array are to be seen in FIG. 1 at a distance f2, and the common focal plane of the second cylindrical lens elements 21a-21c of the second optical array 2 are to be seen at a distance f5 in FIG. 2.

Thus, in the embodiment shown herein, the second optical array 2 is disposed in such a way that the focal plane of the first cylindrical lens elements 20a-20c of the second optical array 2 coincides with the focal plane of the first cylindrical lens elements 10a-12c of the first optical array. Moreover, the focal plane of the second cylindrical lens elements 21a-21c of the second optical array 2 also coincides with the focal plane of the second cylindrical lens elements 13a-15c of the first optical array 1. In the case of the beam splitter configuration shown herein, the second optical array 2 serves as Fourier optics and is used for a first Fourier transformation of the component beams.

The lens system 3, which is disposed downstream of the second optical array 2 in the z-direction, effects a second Fourier transformation of the component beams. On the basis of the twofold Fourier transformation, the second optical array 2 and the lens system 3 are used to image the intensity distribution in the focal planes of the first and second cylindrical lens elements 20a-20c, 21a-21c of the second optical array 2 onto a focal plane of the lens system 3 at a distance f3 from the lens system 3, and in the process that intensity distribution is averaged over the individual apertures of the first and second cylindrical lens elements 20a-20c, 21a-21c. Since in each case three of the first cylindrical lens elements 10a-12c and three of the second cylindrical lens elements 13a-15c of the first cylindrical lens array 1 are assigned to exactly one of the first or second cylindrical lens elements 20a-20c, 21a-21c of the second cylindrical lens array 2, the periodic configuration of the first and second cylindrical lens elements 10a-12c, 13a-15c of the first cylindrical lens array 1 has the effect that very similar intensity distributions can be generated in the focal planes of the first and second cylindrical lens elements 20a-20c, 21a-21c of the second cylindrical lens array 2.

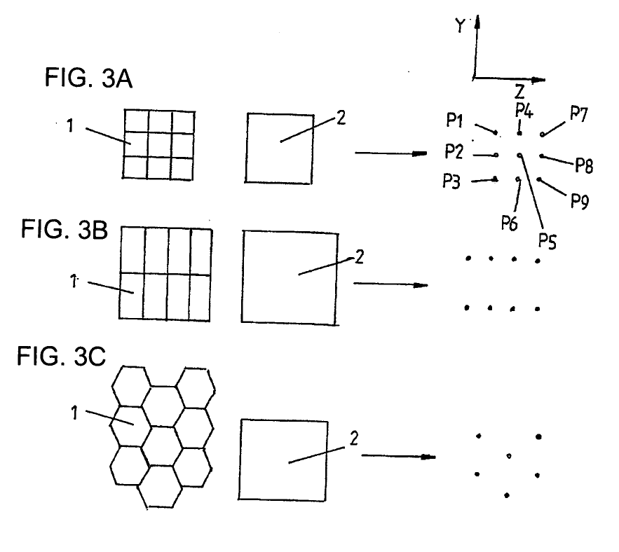

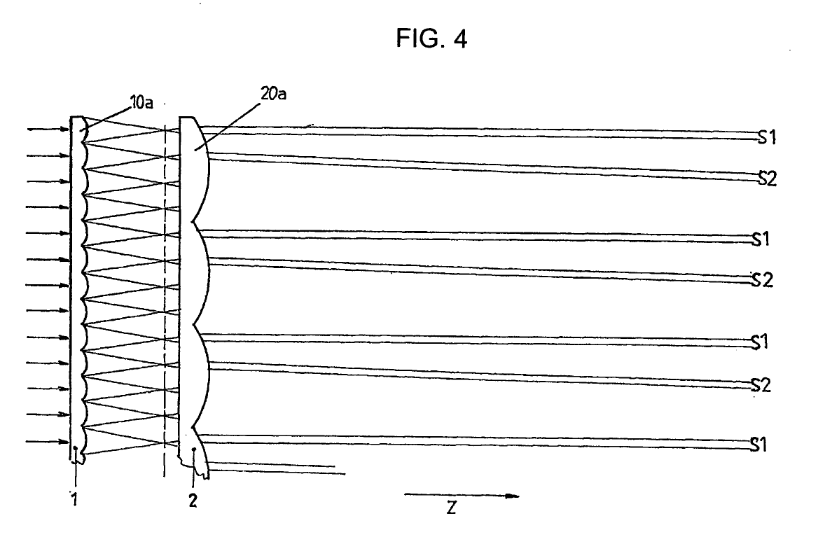

The beam splitter configuration shown in FIG. 1 and FIG. 2 can then be used to generate, at a distance f3 in the image-side focal plane of the lens system 3, a point pattern that corresponds to the averaged intensity pattern at the focal points of the first and second cylindrical lens elements 10a-12c, 13a-15c of the first optical array 1 upstream of each individual one of the first and second cylindrical lens elements 20a-20c, 21a-21c of the second optical array 2. There is thus generated in the focal plane of the lens system 3 a point pattern that has a relatively homogeneous intensity distribution and a total of nine image points P1-P9. This point pattern is illustrated in FIG. 3A.

FIGS. 3A, 3B and 3C show, in a diagrammatic and greatly simplified fashion, different optical arrays 1, 2, which can be used in the beam splitter configuration in FIG. 1 and FIG. 2, as well as the resulting point patterns in the focal plane of the lens system 3. The point pattern illustrated in FIG. 3A and having a total of nine image points P1-P9 can be generated with the beam splitter configuration described in detail above.

If, alternatively, an optical array 1 with two first cylindrical lens elements on the rear side and four second cylindrical lens elements on the front side, which are respectively assigned to one of the first or second cylindrical lens elements 20a-20c, 21a-21c of the second optical array 2, is used in accordance with FIG. 3B, a total of eight image points are obtained in the focal plane of the lens system 3.

An optical array 1 with cylindrical lens elements having cylinder axes on the front or rear sides which are offset from one another, or an optical array with lens elements that have hexagonal apertures, generates a point pattern shown in FIG. 3C, with a total of six image points disposed offset from one another in the focal plane of the lens system 3.

It is very generally evident that it is possible, by suitable selection of the number, shape and geometric configuration of the optically functional elements of the first optical array 1, which are respectively assigned to an optically functional element of the second optical array 2, to vary the number of the resulting image points and their spatial distribution. Thus, for example, the number of the image points generated with the aid of the beam splitter configuration can be varied in a targeted manner through the shape and configuration of the apertures of the lens elements used in the two optical arrays 1, 2.

FIG. 4 shows a diagrammatic view of the beam path of a second embodiment of the present invention. To be seen, once again, is the first optical array 1, which has a plurality of first convexly shaped cylindrical lens elements 10a on its rear side. Disposed downstream of the first optical array 1 in the beam propagation direction (z-direction) is a second optical array 2, which has on its rear side a plurality of convexly shaped first cylindrical lens elements 20a. In the exemplary embodiment illustrated herein, the diameters of the first cylindrical lens elements 20a of the second optical array 2 are, in turn, larger than the diameters of the first cylindrical lens elements 10a of the first optical array 1. The diameters of the first cylindrical lens elements 10a of the first optical array 1 can, for example, be of an order of magnitude of 0.1 to 1 mm. It is to be seen that in this exemplary embodiment, respectively four of the first cylindrical lens elements 10a of the first optical array 1 are exactly assigned to one of the first cylindrical lens elements 20a of the second optical array 2. The optical arrays 1, 2 can likewise have on their front sides second cylindrical lens elements having cylinder axes which can be oriented substantially parallel to one another and perpendicular to the cylinder axes of the first cylindrical lens elements 10a, 20a on the rear sides of the optical arrays 1, 2.

As already explained in detail in conjunction with the first exemplary embodiment in FIG. 1 and FIG. 2, a substantially parallel light beam striking this beam splitter configuration is initially decomposed through the use of the first cylindrical lens elements 10a of the first optical array 1 into a plurality of component beams that are imaged onto a focal plane of the first cylindrical lens elements 10a upstream of the second optical array 2. The second optical array 2 is, in turn, used as Fourier optics. Contrary to the case of the embodiment described in FIGS. 1 and 2, in this exemplary embodiment no further lens system is disposed downstream of the second optical array 2.

To simplify matters, downstream of the second optical array 2, FIG. 4 merely illustrates respectively only the first two of the total of four component beams that have to be observed downstream of each of the cylindrical lens elements 20a. These component beams are denoted by reference symbols S1, S2. It is to be seen that the component beams S1, S2 respectively marked with the same reference symbols run substantially parallel to one another downstream of the second optical array 2. It is then possible to observe, in the far field of each individual cylindrical lens element 20a of the second array 2, an angular distribution of the intensity of the component beams S1, S2 that corresponds to the intensity distribution in the object-side focal plane upstream of the first cylindrical lens elements 20a of the cylindrical lens array 2.

Due to the periodic configuration, already explained above in conjunction with FIG. 1 and FIG. 2, of the first cylindrical lens elements 10a in the first optical array 1, which are assigned to the first cylindrical lens elements 20a of the second optical array 2, the intensity distributions in the focal plane of the first cylindrical lens elements 20a of the second optical array 2 can be very similar. The first cylindrical lens elements 20a of the second optical array 2 therefore generate very similar far fields in such a way that the intensity distribution in the far field is substantially independent of the illumination of the first optical array 1 and independent of the beam profile of the light beam striking the beam splitter configuration. If, as illustrated in FIG. 4, the focal planes of the first cylindrical lens elements 10a, 20a of the two optical arrays 1, 2 coincide, no focal spots are produced in this focal plane that lead to a corresponding number of individual beams having low divergence and different propagation angles in the far field. The effect of this is a relatively uniform and, moreover, also efficient beam division.

1. A beam splitter configuration, comprising:
at least one beam splitter system for decomposing a light beam into a plurality of component beams;
said beam splitter system including at least one first and at least one second optical array being spaced apart from one another and having a plurality of optically functional elements; and
an integral multiple of said optically functional elements of said first optical array being assigned to each respective optically functional element of said second optical array.

2. The beam splitter configuration according to claim 1, wherein said optically functional elements of said optical arrays are lens elements.

3. The beam splitter configuration according to claim 2, wherein said optical arrays are disposed in such a way that said lens elements of said second optical array and said lens elements, assigned thereto, of said first optical array, have common focal planes.

4. The beam splitter configuration according to claim 2, wherein at least a portion of said lens elements of said optical arrays has a convex construction.

5. The beam splitter configuration according to claim 2, wherein at least a portion of said lens elements of said optical arrays has a concave construction.

6. The beam splitter configuration according to claim 2, wherein said lens elements of said optical arrays are spherical lens elements.

7. The beam splitter configuration according to claim 2, wherein said lens elements of said optical arrays are cylindrical lens elements.

8. The beam splitter configuration according to claim 7, wherein:
said cylindrical lens elements of at least one of said optical arrays are first and second cylindrical lens elements disposed on opposite front and rear sides and having cylinder axes; and
said cylinder axes of said first cylindrical lens elements on said rear side of said at least one of said optical arrays are respectively oriented parallel to one another and perpendicular to said cylinder axes of said second cylindrical lens elements on said front side of said at least one of said optical arrays.

9. The beam splitter configuration according to claim 1, which further comprises at least one lens system disposed in a beam path of the light beam, downstream of said second optical array, for focusing the component beams onto a focal plane.

10. The beam splitter configuration according to claim 9, wherein said lens system has a spherical construction.

11. The beam splitter configuration according to claim 1, wherein said optically functional elements of at least one of said optical arrays are mirrors.
